(19) United States
(12) Patent Application Publication
(10) Pub. No.: US 2017/0132727 A1
(43) Pub. Date: May 11, 2017

(54) METHOD, ELECTRONIC DEVICE, AND COMPUTER-READABLE MEDIUM FOR TRAVEL PLANNING

(71) Applicant: Acer Incorporated, New Taipei City (TW)

(72) Inventors: Tsung-Han Yang, New Taipei City (TW); Chien-Hung Lin, New Taipei City (TW); Yu-Chun Wu, New Taipei City (TW); Eugene Yi-Cheng Shen, New Taipei City (TW)

(73) Assignee: Acer Incorporated, New Taipei City (TW)

(21) Appl. No.: 15/261,552

(22) Filed: Sep. 9, 2016

(30) Foreign Application Priority Data
Nov. 5, 2015 (TW) 104136435

(51) Int. Cl. G06Q 50/14; G06Q 10/10

(52) U.S. Cl. CPC G06Q 50/14; G06Q 10/1097

(57) ABSTRACT

A method, an electronic device, and a computer program product for travel planning are provided, where the method is adapted to an electronic device able to be connected to a server and includes the following steps. First, a travel planning schedule including multiple itineraries is obtained, where the itineraries include a first itinerary as well as a second itinerary following the first itinerary. Next, at least one suggested itinerary among multiple uploaded itineraries is obtained from the server according to the first itinerary, and a selecting operation performed on the at least one suggested itinerary is detected. In response to the selecting operation detected on a third itinerary among the at least one suggested itinerary, the third itinerary is inserted between the first itinerary and the second itinerary, and the travel planning schedule is updated accordingly.

### CROSS-REFERENCE TO RELATED APPLICATION

This application claims the priority benefit of Taiwan application serial no. 104136435, filed on Nov. 5, 2015. The entirety of the above-mentioned patent application is hereby incorporated by reference herein and made a part of this specification.

### TECHNICAL FIELD

The disclosure relates to a technique for travel planning.

### BACKGROUND

When it comes to travel planning, the most tedious job is to collect massive data and organize it into a document. The preparation would include collecting data in various formats such as screenshot, map, train schedule, time duration at each attraction, as well as editing and sorting the collected data by time.

However, it is not convenient to edit, add or delete itineraries in a travel planning document organized in the aforesaid fashion, and its interface and layout would be disorganized and unstructured.

### SUMMARY OF THE DISCLOSURE

Accordingly, the disclosure is directed to a method, an electronic device, and a computer-readable medium for travel planning, which provides an approach to conveniently organize collected data for travel planning.

According to one of the embodiments, the disclosure is directed to a method for travel planning. The method is adapted to an electronic device able to be connected to a server, where the server stores uploaded travel planning schedules, each of the uploaded travel planning schedules includes uploaded itineraries, each of the uploaded itineraries includes at least one uploaded data cards, each of the uploaded data cards corresponds to at least one piece of uploaded collected data. The method includes the following steps. First, a travel planning schedule including multiple itineraries is obtained, where the itineraries include a first itinerary as well as a second itinerary following the first itinerary. Next, at least one suggested itinerary among multiple uploaded itineraries is obtained from the server according to the first itinerary, and a selecting operation performed on the at least one suggested itinerary is detected. In response to the selecting operation detected on a third itinerary among the at least one suggested itinerary, the third itinerary is inserted between the first itinerary and the second itinerary, and the travel planning schedule is updated accordingly.

According to one of the embodiments, the disclosure is directed to an electronic device including a screen, an input device, a communication circuit, a memory and a processor, where the processor is coupled to the screen, the input device, the communication circuit, and the memory. The screen is configured to display a display frame. The communication circuit is configured to be connected to a server, where the server stores uploaded travel planning schedules, each of the uploaded travel planning schedules includes uploaded itineraries, each of the uploaded itineraries includes at least one uploaded data cards, each of the uploaded data cards corresponds to at least one piece of uploaded collected data. The input device is configured to detect operations performed thereon. The memory is configured to record modules. The processor is configured to access and execute the modules recorded in the memory. The modules include a travel planning schedule obtaining module, an itinerary suggesting module, and a travel planning schedule updating module. The travel planning schedule obtaining module is configured to obtain a travel planning schedule including multiple itineraries, where the itineraries include a first itinerary and a second itinerary following the first itinerary, each of the itineraries comprises at least one data card, and each of the data cards corresponds to at least one piece of collected data. The itinerary suggesting module is configured to obtain at least one suggested itinerary among the uploaded itineraries from the server according to the first itinerary. In response to the selecting operation detected on a third itinerary among the suggested itineraries, the travel planning updating module is configured to insert the third itinerary between the first itinerary and the second itinerary and updating the travel planning schedule accordingly.

According to one of the embodiments, the disclosure is directed to a non-transitory computer-readable medium storing programs to be loaded into an electronic device able to be connected to the server to perform the following steps. First, a travel planning schedule including multiple itineraries is obtained, where the itineraries include a first itinerary as well as a second itinerary following the first itinerary. Next, at least one suggested itinerary among multiple uploaded itineraries is obtained from the server according to the first itinerary, and a selecting operation performed on the at least one suggested itinerary is detected. In response to the selecting operation detected on a third itinerary among the at least one suggested itinerary, the third itinerary is inserted between the first itinerary and the second itinerary, and the travel planning schedule is updated accordingly.

In view of the aforementioned descriptions, as for the method, the electronic device, and the computer-readable medium for travel planning disclosed herein, more suggested itineraries could be provided for the user based on the association between each of the itineraries in conjunction with data application such as cloud computation and data mining.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a block diagram of an electronic device in accordance with an embodiment of the disclosure.

FIG. 2 illustrates a flowchart of a method for travel planning in accordance with an embodiment of the disclosure.

FIG. 3A illustrates a schematic diagram of a segment of a travel planning document according to an embodiment of the disclosure.

FIG. 3B illustrates a schematic diagram of a data card converted from the segment of the travel planning document in FIG. 3A.

FIG. 3C illustrates a schematic diagram of the data cards in FIG. 3B after sorting.

FIG. 3D illustrates a schematic diagram of an itinerary and its data cards according to an embodiment of the disclosure.

FIG. 3E illustrates a schematic diagram of an itinerary and its data cards according to an embodiment of the disclosure.

FIG. 4 illustrates a block diagram of an electronic device in accordance with an embodiment of the disclosure.

FIG. 5 illustrates a flowchart of a method for travel planning in accordance with an embodiment of the disclosure.

FIG. 6A illustrates a schematic diagram of an approach to obtain suggested itineraries according to an embodiment of the disclosure.

FIG. 6B illustrates a schematic diagram of an approach to obtain suggested itineraries according to another embodiment of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

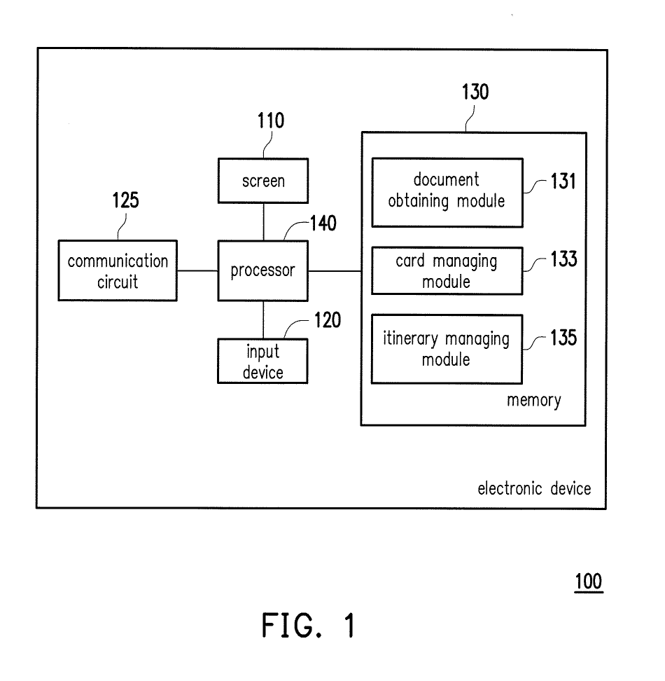

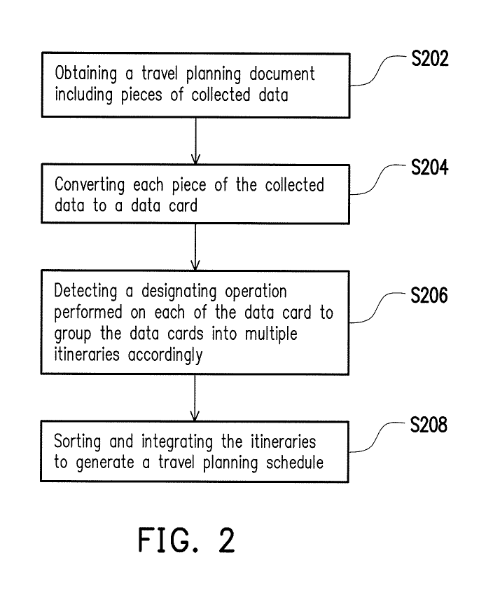

FIG. 1 illustrates a block diagram of an electronic device in accordance with an embodiment of the disclosure. It should, however, be noted that this is merely an illustrative example and the disclosure is not limited in this regard. All components of the electronic device and their configurations are first introduced in FIG. 1. The detailed functionalities of the components are disclosed along with FIG. 2.

Referring to FIG. 1, an electronic device 100 includes a screen 10, an input device 120, a communication circuit 125, a memory 130, and a processor 140. In the present embodiment, the electronic device 100 may be a smart phone, a tabular computer, a personal digital assistant, and so forth. The disclosure is not limited in this regard.

The screen 110 is configured to display a frame output by the electronic apparatus 100 for the user. In the present embodiment, the screen 10 may be a liquid crystal display (LCD), a light-emitting diode (LED) display, a field emission display (FED) or other types of displays.

The input device 120 is configured to provide the user to operate the electronic device 100 and may be an external or built-in keyboard, mouse, stylus pen, touch panel, trackball, and so forth. In an embodiment, the screen 110 and the input device 120 may be integrated as a touch screen (e.g. a resistive touch screen or a capacitive touch screen) which is configured to receive a touch operation of the user.

The communication circuit 125 is configured to connect to the Internet via a communication network. The communication unit 125 may be a component capable of supporting wireless internet access such as WiMAX, Wi-Fi, 2G, 3G, or 4G, wired internet access such as ADSL or optical fibre network. The disclosure is not limited in this regard. The communication circuit 125 is further configured to provide the electronic device 100 to transmit data file with other devices and may be a component able to support proximity wireless transmission or wired transmission. The disclosure is not limited in this regard either.

The memory 130 may be one or a combination of a stationary or mobile random access memory (RAM), a read-only memory (ROM), a flash memory, a hard drive or other similar devices and is configured to store file data. The memory 130 is also configured to record modules executable by the processor 140, where the modules include a document obtaining module 131, a card managing module 133, and an itinerary managing module 135.

The processor 140 may be, for example, a central processing unit (CPU) or other programmable devices for general purpose or special purpose such as a microprocessor and a digital signal processor (DSP), a programmable controller, an application specific integrated circuit (ASIC), a programmable logic device (PLD) or other similar devices or a combination of the aforesaid devices. The processing unit 130 is coupled to the screen 110, an input device 120, the communication circuit 125, and the memory 130 and is configured to access the modules stored in the memory 130 to execute the method for travel planning.

FIG. 2 illustrates a flowchart of a method for travel planning in accordance with an embodiment of the disclosure. The method in the present embodiment may be implemented by the electronic device 100 in FIG. I. Detailed steps of the proposed method would be illustrated along with the components of the electronic device 100.

First, the document obtaining module 131 of the electronic device 100 would obtain a travel planning document including pieces of collected data (Step S202). To be specific, the electronic device 100 may provide a document editor so that the user could enter or paste the collected data thereto by using the input device 120. Besides, the electronic device 100 may also obtain the travel planning document from other electronic devices. The collected data may include at least one data category, and each of the data categories has at least one data format. For example, the data categories of the collected data may be attraction name, hotel address, price, transportation information, photo, related website link, online review, and so forth. The data formats may be text, screenshot, picture, hyperlink, table, and so forth. However, the disclosure is not limited in this regard.

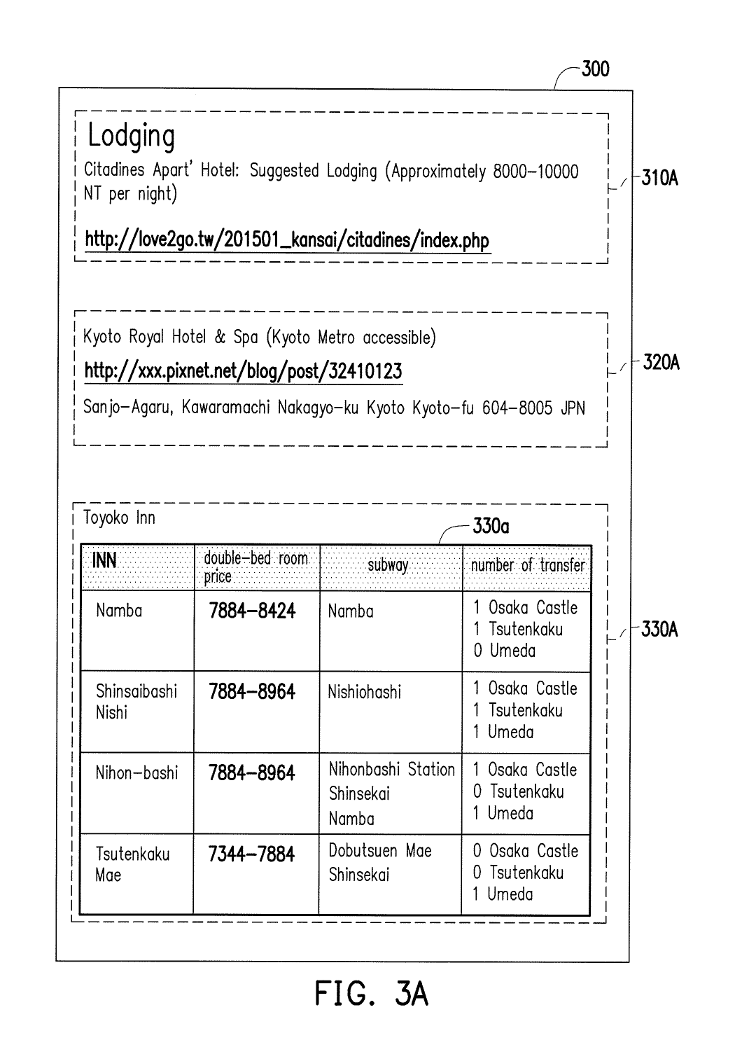

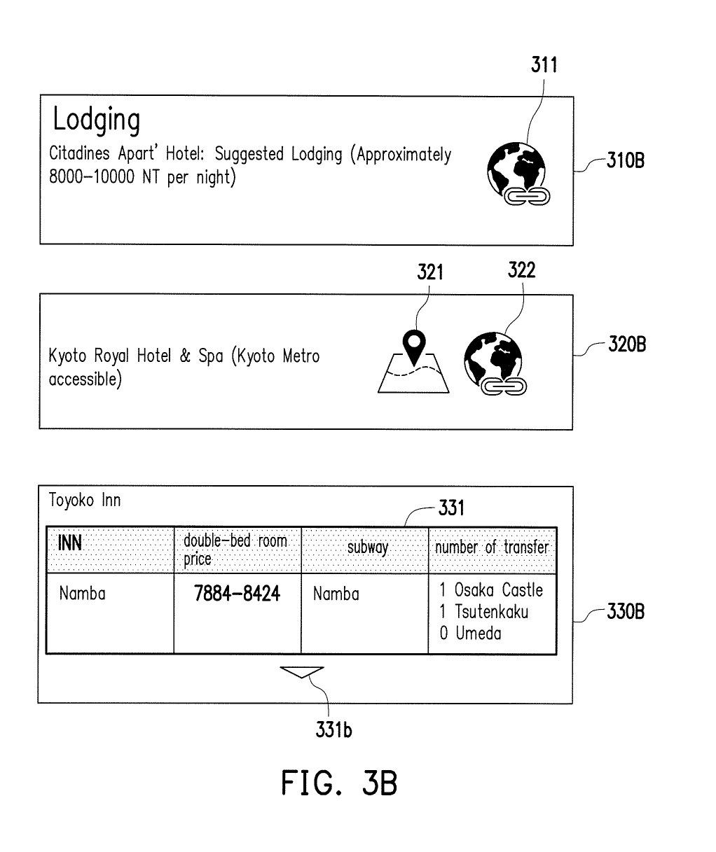

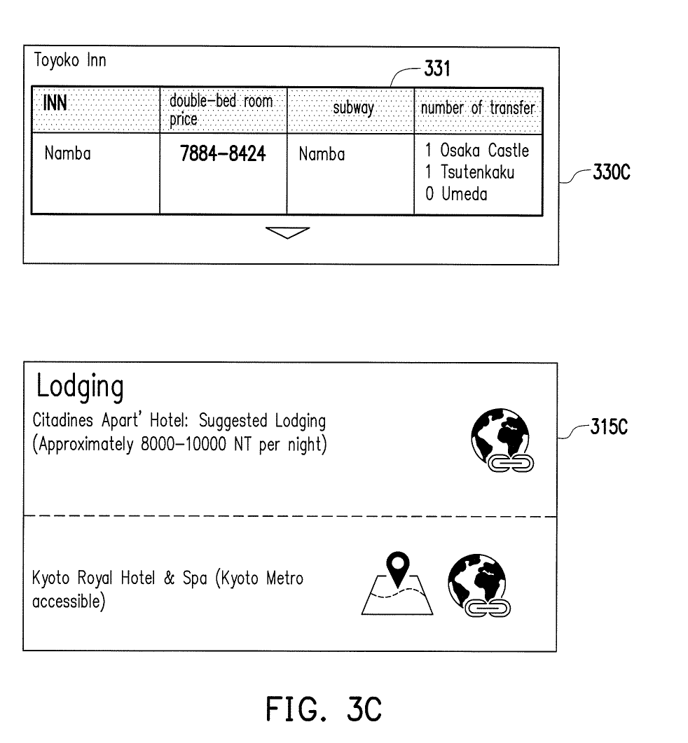

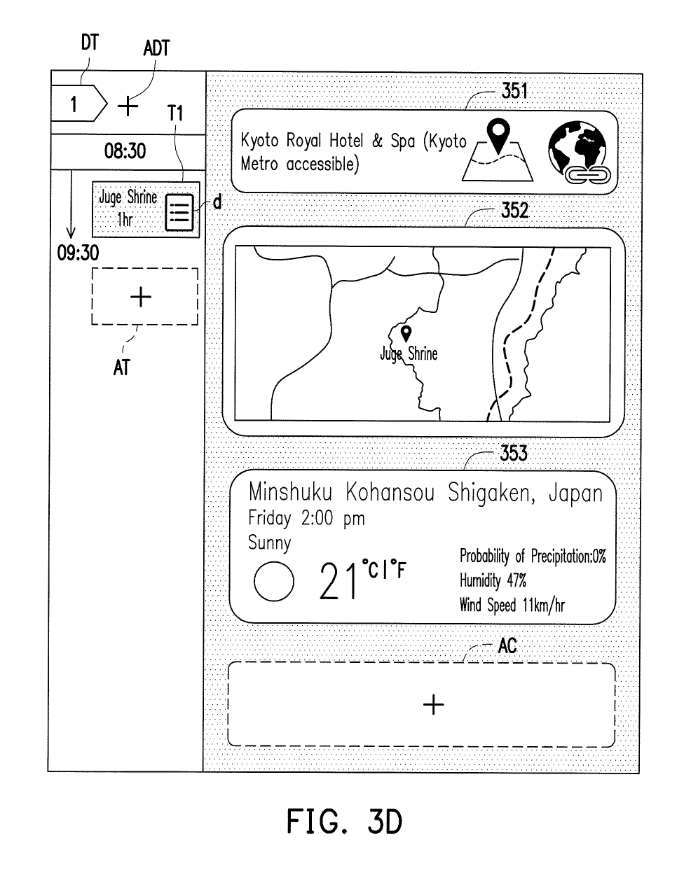

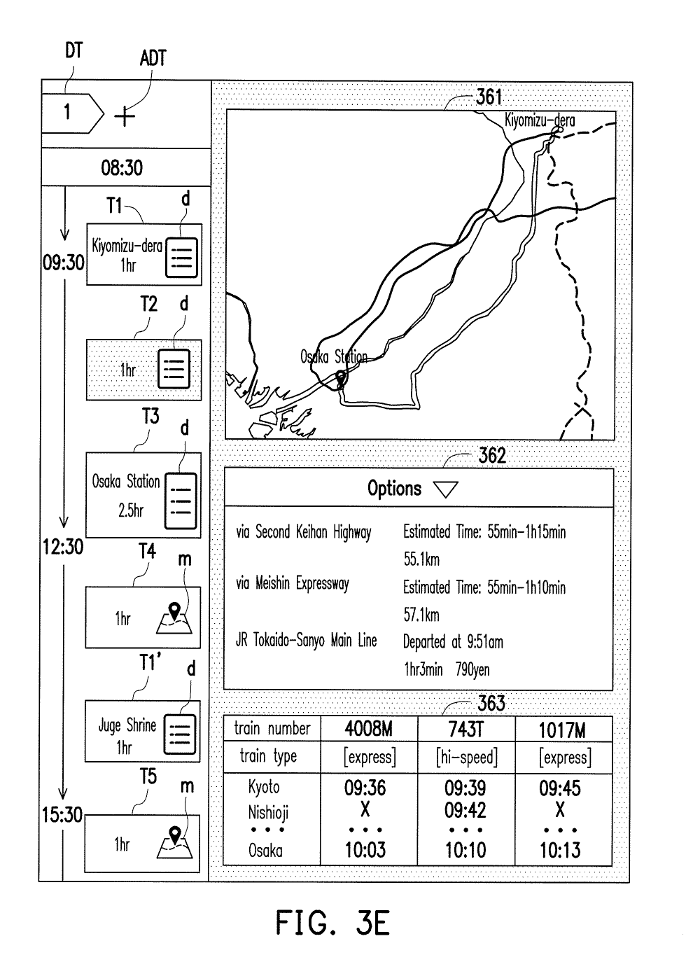

To be specific, FIG. 3A illustrates a schematic diagram of a segment of a travel planning document according to an embodiment of the disclosure.

Referring to FIG. 3A, a segment of a travel planning document 300 includes three pieces of collected data related to lodging. Collected data 310A and collected 310B respectively include related information of two hotels in Kyoto. The collected data 310A includes three categories: hotel name, price, and suggested website, where the data formats of the hotel name and the price are both text, and the data format of the suggested website is hyperlink. The collected data 320A includes four data categories: hotel name, transportation information, suggested website, and hotel address, where the data formats of the hotel name, the transportation information, and the hotel address are text, and the data format of the suggested website is hyperlink. The collected data 330A includes multiple locators of Toyoko Inn hotel chain in Osaka, where the listed locators and their related information (i.e. price and transportation information) are presented in table format.

Revisiting FIG. 2, after the document obtaining module 131 of the electronic device 100 obtains the travel planning document, the card managing module 133 would convert each piece of the collected data to a data card (Step S204). Herein, each of the data cards includes converted collected data. The card managing module 133 may process each piece of the collected data according to the data format of its data category, and the processed collected data would create a clean and organized viewing layout. Next, the card managing module 133 would segment the travel planning document into multiple data segments. In other words, each of the data segments corresponds to a single piece of the collected data. Next, the card managing module 133 would convert the data segments to the data cards.

The card managing module 133 may segment the travel planning document based on the user's habit of editing documents. In general, when the user uses a conventional document editor for travel planning, white space lines are often used for separating multiple pieces of collected data. Hence, the card managing module 133 may detect all positions of white space lines in the travel planning document and accordingly segment the travel planning document. For example, assume that the user is used to separate different itineraries by two white space lines. The card managing module 133 would then segment the travel planning document according to all positions of two white space lines. However, the disclosure is not limited herein. In other embodiments, the card managing module 133 may also segment the travel planning document according to dividing line, font size, specific symbol, or even text content in the travel planning document.

It should be noted that, in another embodiment, the card managing module 133 may first segment the travel planning document into multiple data segments, process the collected data, and then convert the processed data segments to data cards. The disclosure is not limited in this regard.

Three approaches for processing the collected data (referred to as first collected data, second collected data, and third collected data hereafter) performed by the card managing module 133 would be illustrated as follows.

Assume that one data category (referred to as a first data category) of the first collected data is an actual address and its data format is text. The card managing module 133 may obtain an electronic map corresponding to the actual address through a network and extract a uniform resource locator (URL) address of the electronic map.

In an embodiment, the card managing module 133 may add the URL address of the electronic map to the first collected data. In another embodiment, the card managing module 133 may further convert the data format of the first data category to an icon hyperlink of the URL address of the electronic map.

Assume that one data category (referred to as a second data category) of the second collected data is a related website. That is, its corresponding data format is a text hyperlink. The card managing module 133 may convert the data format of the second data category to an icon hyperlink.

Assume that a data format of one data category (referred to as a third data category) of the third collected data is a table. The card managing module 133 may collapse the table to hide a part of the third collected data for saving more space on the viewing layout.

For example, FIG. 3B illustrates a schematic diagram of a data card converted from the segment of the travel planning document in FIG. 3A.

Referring to both FIG. 3A and FIG. 3B, in this example, the hyperlink of the suggested website in the collected data 310A in FIG. 3A would be converted to an icon hyperlink 311 in a data card 310B in FIG. 3B, and the hotel name and the price would remain in text.

In this example, a hyperlink of the suggested website of the collected data 320A in FIG. 3A would be converted to an icon hyperlink 321 in a data card 320B in FIG. 3B, and the hotel name and the price would remain in text. It should be noted that, the hotel address in the collected data 320B would be converted to an icon hyperlink 322 of an URL address of an electronic map. In other words, when the user clicks on the icon hyperlink 322, the screen 110 of the electronic device 100 would display the electronic map corresponding to the hotel address in the collected data 320A.

In this example, a table 330a of the collected data 330A in FIG. 3A would be collapsed to a table 331 of the data card 330B in FIG. 3B, where only the information of the first row of the table 330a would be displayed in the table 331 while other information would be hidden from the display area of the data card 330B. The entire table would be expanded only when the user clicks on an expand object 33 lb.

In the present embodiment, after the card managing module 133 converts the travel planning document to data cards, it would detect sorting operations performed on the data cards by the user through the input device 120, where the sorting operations could be merging the data cards, exchanging the orders of the data cards, and so forth. As an example, FIG. 3C illustrates a schematic diagram of the data cards in FIG. 3B after sorting.

Referring to both FIG. 3B and FIG. 3C, in this example, the user may merge the data card 310B and the data card 320B in FIG. 3B through the input device 20, and then swap the data card 330C and the merged data card 310B and data card 320B. The data card 330C and a merged data card 315C in FIG. 3C would be presented after the aforesaid rearrangement.

In an embodiment, the converted collected data in the data cards could include live content to provide the user for a follow-up search. Such live content could be, for example, weather information and a map of a particular attraction. For example, when a data card includes weather information of a particular attraction, the card managing module 133 of the electronic device 100 may extract the latest weather information from a weather website through the network to update the content of the data card. Hence, the user is able to obtain the real-time local weather through the data card right before the departure of the travel. When a data card includes a map of a particular attraction, the card managing module 133 of the electronic device 100 may update the map in the data card after the user change the attraction of the itinerary.

Revisiting FIG. 2, after the card managing module 133 converts the travel planning document to multiple data cards, the travel managing module 135 would detect a designating operation performed on each of the data cards so as to group the data cards into multiple itineraries accordingly (Step S206). To be specific, the itinerary managing module 135 may construct multiple itineraries, where each of the itineraries may be categorized into an attraction itinerary or a transportation itinerary from a departure place to a destination. Next, the itinerary managing module 135 would add each of the data cards to the designated itinerary according to the designating operation.

For example, FIG. 3D illustrates a schematic diagram of an itinerary and its data cards according to an embodiment of the disclosure. The itinerary in this embodiment is an attraction itinerary.

Referring to FIG. 3D, assume that the user sets an itinerary T1 as “Juge Shrine”. In the present embodiment, the card detecting module 135 would detect that a data card 351, a data card 352, and a data card 353 are dragged into a subset of the itinerary T1 by the user through the input device 120, where the data card 351 includes considered hotels in the surrounding area of Juge Shrine, the data card 352 includes an electronic map of the Juge Shrine, and the data card 353 includes the weather of the region where Juge Shrine is. It should be noted that, the content of the data card 351 is the collected data 320A in FIG. 3A collected by the user, and the contents of the data card 352 and the data card 353 are dynamic live content extracted by the communication circuit 125 periodically through the network. Additionally, the itinerary T1 may further include a prompt object d so that the user would be able to recognize that more than one data card are included in the subset of the itinerary T1.

In this example, the user may further set a staying time in each of the itineraries. For instance, a staying time of the itinerary T1 is set to 1 hour. The user may also click on an operation object AT to add a new itinerary or click on an operation object AC to add a new data card. The user may also delete any itinerary or data card. Besides, a display object DT may indicate that the presented interface is the first day of the travel schedule. After the user finishes arranging the itineraries of the first day or wishes to add more itineraries to other days, he may click on an operating object ADT to add more days to arrange itineraries for those days.

FIG. 3E illustrates a schematic diagram of an itinerary and its data cards according to an embodiment of the disclosure. In the present embodiment, the itinerary is a transportation itinerary.

Referring to FIG. 3E, assume that the user sets an itinerary T2 as a transportation itinerary between an itinerary T1′ and an itinerary T3. That is, the itinerary T2 is a transportation itinerary departing from Kiyomizu-dera and arriving at Osaka station. In the present embodiment, the itinerary managing module 135 would detect that a data card 361, a data card 362, and a data card 363 are dragged into a subset of the itinerary T2 by the user through the input device 120, where the data card 361 is an electronic map covering Kiyomizu-dera and Osaka station, the data card 362 includes three suggested transportation choices from Kiyomizu-dera to Osaka station, and the data card 363 includes a time schedule of JR Tokaido-Sanyo Main Line around 9:30 am to fulfill the user's requirement. The time schedule may be a table, a screenshot, an icon hyperlink of an URL address. The disclosure is not limited in this regard.

Additionally, the itinerary T1′, the itinerary T2, the itinerary T3, and the itinerary T1 may further include prompt objects d so that the user would be able to recognize that more than one data cards are included in the subsets of those itineraries. An itinerary T4 and an itinerary T5 may further include prompt objects in so that the user would be able to recognize that an electronic map is included in a subset of each of those itineraries.

In an embodiment, the user may also rearrange the order of all itineraries at any time. From another viewpoint, the itinerary managing module 135 may detect moving operations performed on the itineraries so as to sort the itineraries. Moreover, the itinerary managing module 135 may integrate the sorted itineraries to the travel planning schedule by days.

The travel planning schedule integrated by the itinerary managing module 135 may provide the user to lookup any of the itineraries. When the user selects any of the itineraries, the itinerary managing module 135 would display the data cards corresponding to the selected itinerary so as to allow the user to view the collected related information of the selected itinerary. In a more convenient fashion, the itinerary module 135 may also automatically display the related itineraries in the travel planning schedule according to the current time or the current location tracked by a global positioning system (GPS, not shown) of the electronic device 100 during the travel.

In the aforementioned embodiments, the electronic device may convert all collected data in the travel planning document edited by a document editor to data cards, place the data cards to their corresponding itineraries and sort the itineraries according to the user's operations so as to generate a travel planning schedule which is easy to be edited and viewed by the user. Moreover, since each piece of the data is converted to a data card format, the electronic device 100 may apply a specific layout format to the travel planning schedule so that a display format of the output travel planning schedule would be compatible with different electronic devices. In other embodiments, while the user is planning for the travel, the electronic device may not only provide suggested attraction itineraries, suggested transportation itineraries, but may also manage the travel planning schedule according to the user's traveling preferences so as to enhance user experience.

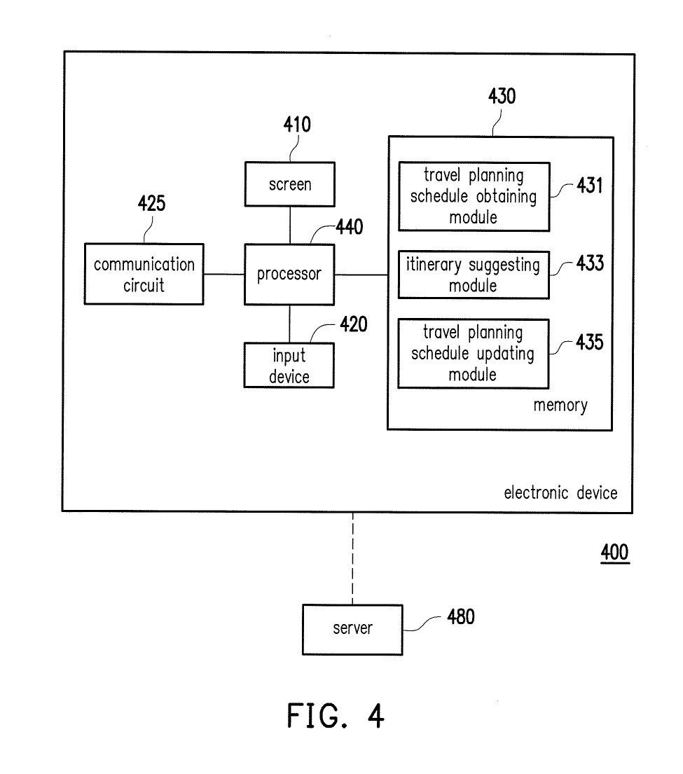

To be specific, FIG. 4 illustrates a block diagram of an electronic device in accordance with an embodiment of the disclosure. It should, however, be noted that this is merely an illustrative example and the disclosure is not limited in this regard.

Referring to FIG. 4, an electronic device 400 includes a screen 410, an input device 420, a communication circuit 425, a memory 430, and a processor 440 respectively similar to the screen 110, the input device 120, the communication circuit 125, a memory 130, and a processor 140 in FIG. 1. Detailed descriptions of the components are provided previously and would not be repeated herein. The difference between the electronic device 400 and the electronic device 100 is that the memory 430 is configured to record a travel planning schedule obtaining module 431, a travel suggesting module 433, and a travel planning schedule updating module 435.

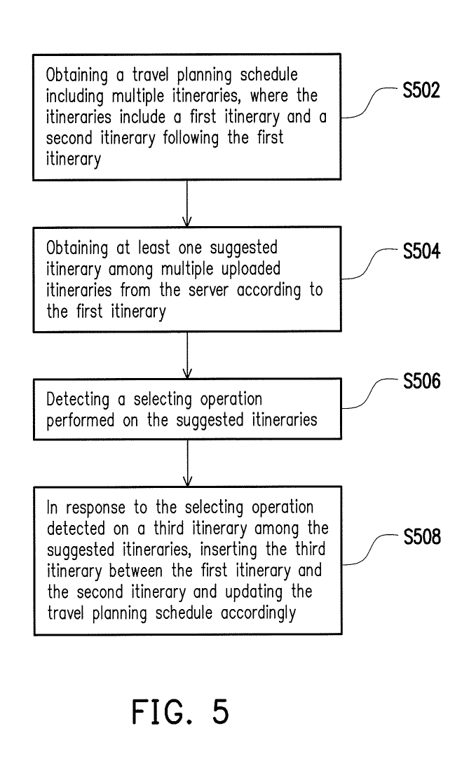

FIG. 5 illustrates a flowchart of a method for travel planning in accordance with an embodiment of the disclosure. The method in the present embodiment may be implemented by the electronic device 400 in FIG. 4. Detailed steps of the proposed method would be illustrated along with the components of the electronic device 400.

First, the travel planning schedule obtaining module 431 of the electronic device 400 would obtain a travel planning schedule including multiple itineraries (Step S502). Herein, the travel planning schedule is integrated by the itinerary managing module 135 in the previous embodiments. That is, each of the itineraries includes at least one data card, and each of the data cards corresponds to at least one piece of collected data.

In the present embodiment, the electronic device 400 may be connected to the server 480 through the communication circuit 425 while the user is planning for the travel. The server 480 may be an application server, a cloud server, and so forth, and prestore multiple travel planning schedules uploaded by other electronic devices (referred to as “uploaded travel planning schedules” hereafter). Similarly, each of the uploaded travel planning schedules includes multiple itineraries (referred to as “uploaded itineraries”), and each of the uploaded itineraries includes at least one data card (referred to as “uploaded data card”, and each of the uploaded data cards corresponds to at least one piece of collected data (i.e. the converted collected data described in the previous embodiments, referred to as “uploaded collected data”). The server 480 may further provide more suggested attractions or transportation for the electronic device 400 based on its current travel planning schedule.

To be specific, the server 480 may perform data mining on the uploaded travel planning schedules and the uploaded itineraries to obtain the association therebtween, and adaptively suggest other itineraries to the electronic device 400 according to its current travel planning schedule. A first itinerary and a second itinerary following the first itinerary in the travel planning schedule of the electronic device 400 would be illustrated as follows, and other itineraries in the travel planning schedule may be deduced in a similar fashion.

Herein, the itinerary suggesting module 433 of the electronic device 400 would obtain at least one suggested itinerary among the uploaded itineraries from the server 480 according to the first itinerary (Step S504). The suggested itineraries could also be categorized into an attraction itinerary or a transportation itinerary. The attraction itinerary may be an itinerary at a specific location such as a tourist attraction, a shopping trip, a restaurant, lodging, and so forth. The transportation itinerary may be a transportation choice from a departure place to a destination. In an embodiment, the itinerary suggesting module 433 may provide suggested attraction or transportation itineraries for the user to select. In another embodiment, the itinerary suggesting module 433 may automatically provide all suggested attraction or transportation itineraries. The disclosure is not limited in this regard.

Assume that the itinerary suggested by the itinerary suggesting module 433 is an attraction itinerary. The itinerary suggesting module 433 may obtain a graphical location associated with the first itinerary (referred to as “a first geographical location”) according to the collected data in the data cards of the first itinerary. Since the data cards in each of the itineraries are not in any particular category, the itinerary suggesting module 433 would first analyze the data cards of the first itinerary so as to obtain the first geographical location, and then obtain at least one of the uploaded itineraries closest to the first geographical location from the server 480.

In an embodiment, the analysis performed by the itinerary suggesting module 433 may be based on electronic maps, addresses. EXIF information of photos in the data cards. For example, assume that the data cards of the first itinerary include store addresses in Canal City Hakata, and then the itinerary suggesting module 433 would estimate that a target location of the itinerary is Canal City Hakata. Next, the itinerary suggesting module 433 may obtain and set itineraries associated with attractions around Canal City Hakata as the suggested itineraries.

In an embodiment, assume that text information of the first itinerary (e.g. in a title filed or a location filed) includes actual location information. The itinerary suggesting module 433 may compare the target location and the actual location information to confirm the accuracy of the actual location information of the first itinerary.

In another embodiment, assume that the text information of the first itinerary does not include any actual location information. The itinerary suggesting module 433 would set the target location as virtual location information of the first itinerary. For example, assume that the title filed of the first itinerary includes non-actual location information such as “dinner”. The itinerary suggesting module 433 would assign “Canal City Hakata” to the virtual location information of the first itinerary. After the first itinerary is uploaded to the server 480 to be one of the uploaded itineraries, when another user needs any suggested attraction itinerary around Hakata at dinner time, the first itinerary would be suggested to him. In other words, the suggested user would see an itinerary named as “dinner” and including the store addresses in Canal City Hakata. In the present embodiment, the accuracy of the virtual location information may be confirmed during the first itinerary by using a GPS of the electronic device 400 to its current location.

Extended from the aforementioned embodiments, in another embodiment, the itinerary suggesting module 433 may obtain and set at least one of the uploaded itineraries closest to the first geographical location and satisfying a time point associated with the first itinerary as the suggested itineraries. Such time point may be, for example, a particular time interval in a day such as a dinner time as illustrated in the previous embodiment, or a particular season such as a sakura season, a maple leaf season, and so forth. The disclosure is not limited in this regard.

In an embodiment, the itinerary suggesting module 433 may obtain and set at least one of the uploaded itineraries following the first itinerary and being most frequently used as the suggested itineraries. For example, assume that the first itinerary is “Canal City Hakata”. The server 480 may find out that most users would visit the Fukuoka tower right after Canal City Hakata. Thus, the itinerary suggesting module 433 may obtain the itinerary “Fukuoka tower” from the server 480 as the suggested itinerary following the itinerary “Canal City Hakata”.

On the other hand, assume that the suggested itineraries are transportation itineraries between two locations. That is, each of the suggested itineraries includes information of a departure place and a destination. The itinerary suggesting module 433 would not only obtain a geographical location associated with the first itinerary (i.e. the first geographical location) according to the collected data in the data cards of the first itinerary, but would also obtain a geographical location associated with the second itinerary (referred to as “second geographical location”) according to the collected data in the data cards of the second itinerary. The way that the itinerary suggesting module 433 obtains the second geographical location is similar to that of the first geographical location, and would not be repeated herein.

In an embodiment, the itinerary suggesting module 433 may obtain and set at least one of the uploaded itineraries from the first geographical location to the second geographical location and being most frequently used as the suggested itineraries. In other words, such suggested itineraries are the most frequent transportation choices from the first geographical location as the departure location and the second geographical location as the destination. For example, when the first geographical location and the second geographical location are respectively Kiyomizu-dera and Osaka, the itineraries suggested by the itinerary suggesting module 433 may be any transportation via Kyoto station.

In mother embodiment, the itinerary suggesting module 433 may further obtain the suggested itineraries from the first geographical location to the second geographical location according to a time point of the first itinerary. For example, in general, subways are more frequently used in daytime, and the Shinkansen are more frequently used in night time. Hence, with the same departure location and the destination, the transportation would be suggested differently by the itinerary suggesting module 433 during daytime and night time.

However, when there is no association between the first geographical location and the second geographical location (i.e. there exists no itinerary from the first geographical location to the second geographical location among the uploaded itineraries in the server 480), the itinerary suggesting module 433 may obtain the suggested itineraries based on the approaches illustrated in the following embodiments.

In an embodiment, the itinerary suggesting module 433 would obtain and set the first geographical location as the departing location and other geographical locations as the destinations as the suggested itineraries, where a distance between the first geographical location and each of the other geographical locations is not greater than that between the first geographical location and the second geographical location.

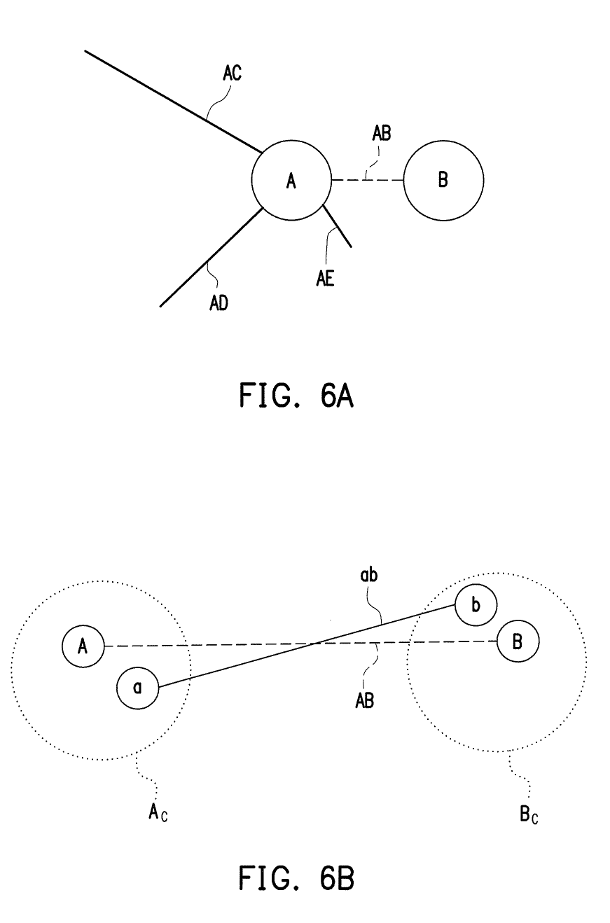

For example, FIG. 6A illustrates a schematic diagram of an approach to obtain suggested itineraries according to an embodiment of the disclosure.

Referring to FIG. 6A, assume that a geographical location A and a geographical location B are a departure location and a destination respectively, and yet a transportation itinerary AB does not exist in the server 480. Assume that the geographical location A is also a departure location of a transportation itinerary AC, a transportation itinerary AD, and a transportation itinerary AE. In the present embodiment, since the distances of the transportation itinerary AC and the transportation itinerary AD are greater than that between the geographical location A (the departing location) and the geographical location B (the destination), the itinerary suggesting module 433 would not consider the two transportation itineraries as the suggested itineraries. On the other hand, since the distance of the transportation itinerary AE is less than the distance of the transportation itinerary AB, the itinerary suggesting module 433 may further check if there exists any transportation between the geographical location E and the geographical location B. If yes, the itinerary suggesting module 433 would list it as a suggested itinerary to inform the user how to travel from the geographical location E to the geographical location B, and the user may be able to travel from the geographical location A to the geographical location B via the geographical location E.

In another embodiment, the itinerary suggesting module 433 would obtain and set at least one of the frequently-used uploaded itineraries from the first geographical location to a substitute second geographical location as the suggested itineraries. The substitute geographical location is a geographical location nearby to the second geographical location. In other words, the second geographical location is enhanced to a higher hierarchical level geographically. For example, a distance between the second geographical location and the substitute second geographical location is not greater than a distance threshold, or the second geographical location and the substitute geographical location belong to a same district.

For example, FIG. 6B illustrates a schematic diagram of an approach to obtain suggested itineraries according to another embodiment of the disclosure.

Referring to FIG. 6B, assume that the geographical location A and the geographical location B are a departure location and a destination respectively, and yet the transportation itinerary AB does not exist in the server 480. The itinerary suggesting module 433 may set at least one of the uploaded itineraries obtained from the server 480 from the geographical A to a geographical location b substituting for the geographical location B as the suggested itineraries, where the geographical location b is within a specific distance range B_{C} from the geographical location B.

In another embodiment, assume that there exists no transportation itinerary corresponding to either the first geographical location or the second geographical location. The itinerary suggesting module 433 may set at least one of the uploaded itineraries obtained from the server 480 from a substitute first geographical location to a substitute second geographical location as the suggested itineraries, where a distance between the first geographical location and the substitute first geographical location is not greater than the distance threshold, and a distance between the second geographical location and the substitute second geographical location is not greater than the distance threshold. The substitute first geographical location and the substitute second geographical location are geographical locations nearby to the first geographical location and the second geographical location respectively. That is, the first geographical location and the second geographical location are both enhanced to a higher hierarchical level geographically. Similarly, the distance between the actual geographical location and the substitute geographical location may not be greater than the distance threshold, or the actual geographical location and the substitute location belong to a same district.

Also referring to FIG. 6B, assume that the geographical location A and the geographical location B are a departure location and a destination respectively, and yet the transportation itinerary AB does not exist in the server 480. The itinerary suggesting module 433 may set at least one of the uploaded itineraries obtained from the server 480 from a geographical location a to a geographical transportation b, where the geographical location a is within a specific distance range A_{C} from the geographical location A, and the geographical location b is within a specific distance range B_{C} from the geographical location B.

Revisiting FIG. 5, after the itinerary suggesting module 433 obtains the suggested itineraries, it would detect a selecting operation performed on the suggested itineraries (Step S506). In response to the selecting operation performed on a third itinerary among the suggested itineraries by the user, the travel planning schedule updating module 435 would insert the third itinerary between the first itinerary and the second itinerary and update the travel planning schedule accordingly (step S508). In other words, after the user of the electronic device 400 selects a particular suggested itinerary (i.e. the third itinerary) through the input device 420, the travel planning schedule updating module 435 would insert it in the travel planning schedule and completes the update.

In an embodiment, the way that travel planning schedule updating module 435 updates the travel planning schedule may be based on the user's past experience so as to enhance travel planning. To be specific, the travel planning schedule updating module 435 may obtain at least one used travel planning schedule belonging to the same user and calculate preference parameters in travel planning according to the used travel planning schedules. Such preference parameters may be, for example, the number of travelling days, the number of visited attractions per day, lodging and dining habits. The travel planning updating module 435 may rearrange the travel planning schedule based on the preference parameters in a quantitative evaluation approach so that the updated travel planning schedule is much closer to the user's travelling habits.

In an embodiment, after the user completes travel planning, the electronic device 400 would automatically or ask if the user would like to upload the travel planning schedule to the server 480 to be one of the uploaded travel planning schedules as a reference for other users.

The disclosure also provides non-transitory computer readable mediums, which record computer program to be loaded into electronic devices to execute the steps of the aforementioned methods for travel planning in FIG. 2 and FIG. 5 respectively. The computer program is composed of a plurality of program instructions (for example, an organization chart, establishing program instruction, a table approving program instruction, a setting program instruction, and a deployment program instruction, etc.), and these program instructions are loaded into the electronic device 100 and the electronic device 400 and executed by the same to accomplish various steps of the aforementioned method for travel planning.

Moreover, it should be noted that, in an embodiment, the electronic device 400 and the electronic device 100 may be integrated into a same device, and a memory of the integrated electronic device may include the document obtaining module 131, the card managing module 133, the itinerary managing module 135, the travel planning document obtaining module 431, the itinerary suggesting module 433, and the travel planning schedule updating module 435, where the integrated electronic device is able to execute the steps of the aforementioned methods for travel planning in FIG. 2 and FIG. 5. Also, the computer readable mediums may also be integrated, and after the computer program recorded in the integrated computer readable medium is loaded to the integrated electronic device, the steps of the aforementioned methods for travel planning in FIG. 2 and FIG. 5 would be executed.

In view of the aforementioned descriptions, as for the method, the electronic device, and the computer-readable medium for travel planning disclosed herein, all collected data in a travel planning document edited by a user through a document editor is converted to data cards. The data cards are placed to their corresponding itineraries and the itineraries are sorted according to the user's operations so as to generate a travel planning schedule which is easy to be edited and viewed by the user. Since each piece of the data is converted to a data card format, a specific layout format could be applied to the travel planning schedule so that a display format of the output travel planning schedule would be compatible with different electronic devices. In addition, more suggested itineraries could be provided for the user based on the association between each of the itineraries in conjunction with data application such as cloud computation and data mining. Hence, not only the user experience would be enhanced, but the development and the business effect would also be maximized.

No clement, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for travel planning, adapted to an electronic device able to be connected to a server, wherein the server stores a plurality of uploaded travel planning schedules, each of the uploaded travel planning schedules comprises a plurality of uploaded itineraries, each of the uploaded itineraries comprises at least one uploaded data cards, each of the uploaded data cards corresponds to at least one piece of uploaded collected data, and wherein the method comprises:
obtaining a travel planning schedule comprising a plurality of itineraries, wherein the itineraries comprise a first itinerary and a second itinerary following the first itinerary, each of the itineraries comprises at least one data card, and each of the data cards corresponds to at least one piece of collected data;
obtaining at least one suggested itinerary among the uploaded itineraries from the server according to the first itinerary;
detecting a selecting operation performed on the suggested itineraries; and
in response to the selecting operation detected on a third itinerary among the suggested itineraries, inserting the third itinerary between the first itinerary and the second itinerary and updating the travel planning schedule accordingly.

2. The method according to claim 1, wherein each of the suggested itineraries is an attraction, and wherein before the step of obtaining the at least one suggested itinerary among the uploaded itineraries from the server according to the first itinerary, the method further comprises:
obtaining a first geographical location associated with the first itinerary according to the collected data in the data cards of the first itinerary.

3. The method according to claim 2, wherein the step of obtaining the at least one suggested itinerary among the uploaded itineraries from the server according to the first itinerary comprises:
obtaining and setting at least one of the uploaded itineraries closest to the first geographical location as the suggested itineraries.

4. The method according to claim 2, wherein the step of obtaining the at least one suggested itinerary among the uploaded itineraries from the server according to the first itinerary comprises:
obtaining and setting at least one of the uploaded itineraries closest to the first geographical location and satisfying a time point associated with the first itinerary as the suggested itineraries.

5. The method according to claim 2, wherein the step of obtaining the at least one suggested itinerary among the uploaded itineraries from the server according to the first itinerary comprises:
obtaining and setting at least one of the uploaded itineraries following the first itinerary and being most frequently used as the suggested itineraries.

6. The method according to claim 1, wherein each of the suggested itineraries is a transportation choice from a departure place to a destination, and wherein before the step of obtaining the at least one suggested itinerary among the uploaded itineraries from the server according to the first itinerary, the method further comprises:
obtaining a first geographical location associated with the first itinerary according to the collected data in the data cards of the first itinerary; and
obtaining a second geographical location associated with the second itinerary according to the collected data in the data cards of the second itinerary.

7. The method according to claim 6, wherein when the uploaded itineraries comprise a transportation choice from the first geographical location to the second geographical location, the step of obtaining the at least one suggested itinerary among the uploaded itineraries from the server according to the first itinerary comprises:
obtaining and setting at least one of the uploaded itineraries from the first geographical location to the second geographical location and being most frequently used as the suggested itineraries.

8. The method according to claim 6, wherein when the uploaded itineraries do not comprise any transportation choice from the first geographical location to the second geographical location, the step of obtaining the at least one suggested itinerary among the uploaded itineraries from the server according to the first itinerary comprises:
obtaining and setting at least one of the uploaded itineraries from the first geographical location to at least one other geographical location and being most frequently used as the suggested itineraries, wherein a distance between the first geographical location and each of the at least one other geographical location is not greater than that between the first geographical location and the second geographical location.

9. The method according to claim 6, wherein when the uploaded itineraries do not comprise any transportation choice from the first geographical location to the second geographical location, the step of obtaining the at least one suggested itinerary among the uploaded itineraries from the server according to the first itinerary comprises:
obtaining and setting at least one of the uploaded itineraries from the first geographical location to a substitute second geographical location as the suggested itineraries, wherein a distance between the second geographical location and the substitute second geographical location is not greater than a distance threshold.

10. The method according to claim 6, wherein when the uploaded itineraries do not comprise any transportation choice from the first geographical location to the second geographical location, the step of obtaining the at least one suggested itinerary among the uploaded itineraries from the server according to the first itinerary comprises:
obtaining and setting at least one of the uploaded itineraries from a substitute first geographical location to a substitute second geographical location as the suggested itineraries, wherein a distance between the first geographical location and the substitute first geographical location is not greater than a distance threshold, and a distance between the second geographical location and the substitute second geographical location is not greater than the distance threshold.

11. The method according to claim 6, wherein the step of obtaining the at least one suggested itinerary among the uploaded itineraries from the server according to the first itinerary comprises:
obtaining and setting at least one of the uploaded itineraries from the first geographical location to the second geographical location and satisfying a time point associated with the first itinerary as the suggested itineraries.

12. The method according to claim 1, wherein the step of updating the travel planning schedule further comprises:
obtaining a plurality of used travel planning schedules with a same user as the travel planning schedule;
calculating a plurality of preference parameters of the user in travel planning according to the used travel planning schedules; and
sorting the travel planning schedule according to the preference parameters to update the travel planning schedule.

13. An electronic device comprising:
a screen, configured to display a frame;
a communication circuit, configured to be connected to a server, wherein the server stores a plurality of uploaded travel planning schedules, each of the uploaded travel planning schedules comprises a plurality of uploaded itineraries, each of the uploaded itineraries comprises at least one uploaded data cards, each of the uploaded data cards corresponds to at least one piece of uploaded collected data;
an input device, configured to detect operations performed on the electronic device;
a memory, configured to record a plurality of modules;
a processor, coupled to the screen, the input device, the communication circuit, and the memory, and configured to access and execute the modules recorded in the memory, wherein the modules comprise:
a travel planning schedule obtaining module, obtaining a travel planning schedule comprising a plurality of itineraries, wherein the itineraries comprise a first itinerary and a second itinerary following the first itinerary, each of the itineraries comprises at least one data card, and each of the data cards corresponds to at least one piece of collected data;
an itinerary suggesting module, obtaining at least one suggested itinerary among the uploaded itineraries from the server according to the first itinerary; and
a travel planning schedule updating module, detecting a selecting operation performed on the suggested itineraries, and in response to the selecting operation detected on a third itinerary among the suggested itineraries, inserting the third itinerary between the first itinerary and the second itinerary and updating the travel planning schedule accordingly.

14. A non-transitory computer-readable medium, storing programs to be loaded into an electronic device able to be connected to a server to perform steps of:
obtaining a travel planning schedule comprising a plurality of itineraries, wherein the itineraries comprise a first itinerary and a second itinerary following the first itinerary, each of the itineraries comprises at least one data card, and each of the data cards corresponds to at least one piece of collected data;
obtaining at least one suggested itinerary among the uploaded itineraries from the server according to the first itinerary;
detecting a selecting operation performed on the suggested itineraries; and
in response to the selecting operation detected on a third itinerary among the suggested itineraries, inserting the third itinerary between the first itinerary and the second itinerary and updating the travel planning schedule accordingly.
